(19) United States
(12) Patent Application Publication
(10) Pub. No.: US 2026/0358763 A1
(43) Pub. Date: Nov. 12, 2026

(54) OPTIMIZATION METHOD AND DEVICE FOR FEEDFORWARD-TYPE FIRST-ORDER ADRC CONTROLLER

(71) Applicant: CHINA ENERGY SCIENCE AND TECHNOLOGY RESEARCH INSTITUTE CO., LTD., Nanjing (CN)

(72) Inventors: Yuxia LIU, Nanjing (CN); Runze YAN, Nanjing (CN); Xi ZHANG, Nanjing (CN); Guochao FAN, Nanjing (CN); Ming CHEN, Nanjing (CN); Hui WAN, Nanjing (CN)

(21) Appl. No.: 19/577,423

(22) Filed: Mar. 25, 2026

Related U.S. Application Data
(63) Continuation of application No. PCT/CN2026/081993, filed on Mar. 6, 2026.

(30) Foreign Application Priority Data
May 6, 2025 (CN) 202510577302.3

(51) Int. Cl. G05B 6/02

(52) U.S. Cl. CPC G05B 6/02

(57) ABSTRACT

Provided are an optimization method and device for a feedforward-type first-order ADRC controller. A feedforward link is added subsequent to setting values in the first-order linear ADRC system and the feedforward link is used as the transition link of the system.

This application is a continuation of International Patent Application No. PCT/CN2026/081993, filed on Mar. 6, 2026, which claims the priority to Chinese patent application No. 202510577302.3, filed with the China National Intellectual Property Administration on May 6, 2025 and entitled “OPTIMIZATION METHOD AND DEVICE FOR FEEDFORWARD-TYPE FIRST-ORDER ADRC CONTROLLER”, both of which are incorporated herein by reference in their entireties.

### FIELD

The present disclosure belongs to the technical field of automatic control, and in particular, to an optimization method and device for a feedforward-type first-order ADRC controller.

### BACKGROUND

In the field of modern industrial automation, a control system plays a crucial role in ensuring stable and efficient operation of equipment. Active Disturbance Rejection Control (ADRC) technology has attracted widespread attention due to its advantages of strong robustness against internal and external disturbances in the control system and not requiring an accurate mathematical model. A first-order linear active disturbance rejection control system, as the most basic and simple form of the ADRC technology, is widely used in an application scenario that has predetermined requirements for control accuracy and dynamic performance while having relatively low system complexity.

The first-order linear active disturbance rejection control system is mainly composed of a linear extended state observer (LESO) and a linear state error feedback (LSEF) control law. Traditionally, four to-be-tuned parameters are required in total, and are linear extended state observer parameters β₁ and β₂, a linear error feedback control law parameter kₚ, and a control quantity gain b₀, respectively. Accurate tuning of these parameters is crucial for optimizing system performance. However, there are complex correlations between the parameters, and a large amount of debugging work is required for different application scenarios, which makes the parameter tuning process extremely cumbersome. To overcome these difficulties, Professor Gao Zhiqiang proposed a bandwidth parameterization method. This method deeply analyzes an internal connection of control parameters, establishes a correlation between the parameters by virtue of characteristics of bandwidth parameters, simplifies a coupling relationship between the parameters, and reduces the number of to-be-tuned parameters to 3, i.e., an extended state observer bandwidth ωₒ, a linear error feedback law bandwidth ω_{c}, and b₀, which reduces tuning difficulty to some extent.

Based on the above research, some researchers have proposed a simpler and more effective parameter tuning method for a time-delay system, which further promotes application of first-order linear ADRC in the engineering field. They reduced the number of to-be-tuned parameters to 2, which are λ and b₀, respectively, where λ=ω_{c}/ωₒ and 0<λ≤1. This method has shown extremely excellent performance under various operation conditions. However, when a value of λ is small, a response speed of the control system in set value tracking is relatively slow.

### SUMMARY

The present disclosure aims to solve at least one of the technical problems existing in the related art. To this end, the present disclosure proposes an optimization method and device for a feedforward-type first-order ADRC controller, which can significantly improve dynamic response performance of a system. In some embodiments, this improvement is manifested in the system having a faster response speed, smaller overshoot, and better stability when faced with an abrupt signal and noise interference.

In a first aspect, the present disclosure provides an optimization method for a feedforward-type first-order ADRC controller. A feedforward link G_{F} is added to a classical linear active disturbance rejection control system. The method includes: S1: identifying parameters of a transfer function Gₚ of a first-order inertial time-delay system being a controlled object by using a step response curve method or a method for simplifying the transfer function, in which the parameters of the transfer function of the controlled object include a steady-state gain, an inertial time constant, and a delay time; S2: subsequent to completing identification of the parameters of the transfer function Gₚ of the controlled object, expressing a linear extended state observer as:

$$\{ \begin{matrix}{\dot{z}}_{1} ( t ) = {z}_{2} ( t ) + {b}_{0} u ( t ) - {β}_{1} ( {z}_{1} ( t ) - y ( t ) ) \\ {\dot{z}}_{s} ( t ) = - {β}_{2} ( {z}_{1} ( t ) - y ( t ) )\end{matrix} ,$$

in which: t represents a time, r(t), u(t), and y(t) respectively represent a system reference value, an input value, and an output value, and z₁(t) and z₂(t) represent state variable estimated values; a feedback law is u₀(t)=kₚ(r(t)−z₁(t)); and a compensation law is

$$u ( t ) = \frac{{u}_{0} ( t ) - {z}_{2} ( t )}{{b}_{0}} ;$$

and defining an extended state observer bandwidth ωₒ and a linear error feedback law bandwidth ω_{c} by using a bandwidth parameterization method, and calculating linear extended state observer parameters β₁ and β₂ and a linear error feedback control law parameter kₚ, where

$${β}_{1} = 2 {ω}_{o} , {β}_{2} = {ω}_{o}^{2} , and {k}_{p} = {ω}_{c} ,$$

in which to-be-tuned parameters for first-order linear active disturbance rejection control include ωₒ, ω_{c}, and a control quantity gain b₀ of the extended state observer, to simplify parameter tuning; S3: defining a bandwidth of a first-order active disturbance rejection controller as

$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} ,$$

so that ω_{c}=(1+2λ)ω_{A} and

$${ω}_{o} = \frac{1 + 2 λ}{λ} {ω}_{A} ,$$

### and in S2,

$${β}_{1} = \frac{2 ( 1 + 2 λ )}{λ} {ω}_{A} , {β}_{2} = \frac{2 {( 1 + 2 λ )}^{2}}{{λ}^{2}} {ω}_{A}^{2} ,$$

and kₚ=(1+2λ)ω_{A}, and the to-be-tuned parameters include ω_{A}, λ and b₀; and S4: adding a feedforward link to first-order linear ADRC, that is, adding a feedforward transfer function

$${G}_{F} ( s ) = \frac{{T}_{1} s + 1}{{( {T}_{2} s + 1 )}^{2}}$$

subsequent to setting values, in which T₁ and T₂ are parameters of the feedforward link, the feedforward link serves as a transition link of the first-order ADRC, system input is r=r₀G_{F}.

According to an embodiment of the present disclosure, in S2, for the controlled object being the first-order inertial time-delay system, the transfer function is determined based on the following formula:

$${G}_{p} ( s ) = \frac{y ( s )}{u ( s )} = \frac{K}{T s + 1} {e}^{τ s} ,$$

where: Gₚ(s) is the transfer function; u(s) and y(s) are Laplace transforms of system input u(t) and system output y(t), respectively; K is the steady-state gain, and T is the inertial time constant; and τ is the delay time.

According to an embodiment of the present disclosure, in S3, λ is in a range of 0<λ≤1.

According to an embodiment of the present disclosure, in S3, the controller is designed according to a pole-zero cancellation principle, and

$${ω}_{A} = \frac{{ω}_{o}^{2} {ω}_{c}}{2 {ω}_{o} {ω}_{c} + {ω}_{o}^{2}} = \frac{1}{T} ,$$

where: ω_{A} is the bandwidth of the first-order active disturbance rejection controller; ωₒ is the extended state observer bandwidth; ω_{c} is the linear error feedback law bandwidth; and T is the inertial time constant.

According to an embodiment of the present disclosure, in S4, when the controller is implemented in DCS or PLC configuration, there is no feedforward transfer function

$$\frac{{T}_{1} s + 1}{{( {T}_{2} s + 1 )}^{2}} ;$$

and two lead-lag links are used for configuration. A numerator time constant of the first lead-lag link is 0, and denominator time constants of the two lead-lag links are the same, that is,

$${G}_{F} ( s ) = \frac{1}{{T}_{2} s + 1} \times \frac{{T}_{1} s + 1}{{T}_{2} s + 1} .$$

According to an embodiment of the present disclosure, T₂>0; and T₁ is greater than T₂.

According to an embodiment of the present disclosure,

$${T}_{1} = \frac{1}{{ω}_{c}} ,$$

where ω_{c} is the linear error feedback law bandwidth; and

$${T}_{2} = \frac{1}{{ω}_{0}} ,$$

where ωₒ is the extended state observer bandwidth.

According to an embodiment of the present disclosure, in a case that

$${ω}_{A} = \frac{1}{T} ,$$

an initial value of the control quantity gain b₀ of the extended state observer is determined based on the following formula:

$${b}_{0} = max \{ \begin{matrix}2 \frac{K}{T} \frac{τ}{T} \frac{{( 1 + 2 λ )}^{2}}{λ ( 2 + λ )} , & \frac{K}{T} \} .\end{matrix}$$

According to an embodiment of the present disclosure, the optimization method for the feedforward-type first-order ADRC controller includes: starting from the initial value of the control quantity gain b₀ of the extended state observer, gradually reducing the control quantity gain b₀ of the extended state observer, to make overshoot of closed-loop control be smaller than or equal to 5%; or starting from the initial value of the control quantity gain b₀ of the extended state observer, gradually increasing the control quantity gain b₀ of the extended state observer, to make no overshoot occur during the closed-loop control.

In a second aspect, the present disclosure provides an optimization device for a feedforward-type first-order ADRC controller. A feedforward link G_{F} is added to a classical linear active disturbance rejection control system. The device includes: a first processing module configured to identify parameters of a transfer function Gₚ of a first-order inertial time-delay system being a controlled object by using a step response curve method or a method for simplifying the transfer function, in which the parameters of the transfer function of the controlled object include a steady-state gain, an inertial time constant, and a delay time; a second processing module configured to, subsequent to completing identification of the parameters of the transfer function Gₚ of the controlled object, express a linear extended state observer as:

$$\{ \begin{matrix}{\dot{z}}_{1} ( t ) = {z}_{2} ( t ) + {b}_{0} u ( t ) - {β}_{1} ( {z}_{1} ( t ) - y ( t ) ) \\ {\dot{z}}_{2} ( t ) = {β}_{2} ( {z}_{1} ( t ) - y ( t ) )\end{matrix} ,$$

in which: t represents a time, r(t), u(t), and y(t) respectively represent a system reference value, an input value, and an output value, and z₁(t) and z₂(t) represent state variable estimated values; a feedback law is u₀(t)=kₚ(r(t)−z₁(t)); and a compensation law is

$$u ( t ) = \frac{{u}_{0} ( t ) - {z}_{2} ( t )}{{b}_{0}} ;$$

and define an extended state observer bandwidth ωₒ and a linear error feedback law bandwidth ω_{c} by using a bandwidth parameterization method, and calculate linear extended state observer parameters β₁ and β₂ and a linear error feedback control law parameter kₚ, where

$${β}_{1} = 2 {ω}_{o} , {β}_{2} = {ω}_{o}^{2} , and {k}_{p} = {ω}_{c} ,$$

in which to-be-tuned parameters for first-order linear active disturbance rejection control include ωₒ, ω_{c}, and a control quantity gain b₀ of the extended state observer, to simplify parameter tuning; a third processing module configured to define a bandwidth of a first-order active disturbance rejection controller as

$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} , so that {ω}_{c} = ( 1 + 2 λ ) {ω}_{A} and {ω}_{o} = \frac{1 + 2 λ}{λ} {ω}_{A} ,$$

and in the second processing module,

$${β}_{1} = \frac{2 ( 1 + 2 λ )}{λ} {ω}_{A} , {β}_{2} = \frac{{( 1 + 2 λ )}^{2}}{{λ}^{2}} {ω}_{A}^{2} , and {k}_{p} = ( 1 + 2 λ ) {ω}_{A} ,$$

and the to-be-tuned parameters include ω_{A}, λ and b₀; and a fourth processing module configured to add a feedforward link to first-order linear ADRC, that is, add a feedforward transfer function

$${G}_{F} ( s ) = \frac{{T}_{1} s + 1}{{( {T}_{2} s + 1 )}^{2}}$$

subsequent to setting values. T₁ and T₂ are parameters of the feedforward link. The feedforward link serves as a transition link of the first-order ADRC, then system input is r=r₀G_{F}.

In a third aspect, the present disclosure provides an electronic device. The electronic device includes a memory, a processor, and a computer program stored in the memory and executable on the processor. The processor, when executing the computer program, implements the optimization method for the feedforward-type first-order ADRC controller as described in the above first aspect.

In a fourth aspect, the present disclosure provides a non-transitory computer-readable storage medium, having a computer program stored thereon. The computer program, when executed by a processor, implements the optimization method for the feedforward-type first-order ADRC controller as described in the above first aspect.

In a fifth aspect, the present disclosure provides a computer program product. The computer program product includes a computer program. The computer program, when executed by a processor, implements the optimization method for the feedforward-type first-order ADRC controller as described in the above first aspect.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a block diagram of a feedforward-type first-order ADRC control system according to an embodiment of the present disclosure.

FIG. 2 is a configuration diagram of a feedforward link G_{F} according to an embodiment of the present disclosure.

FIG. 3 is a simplified diagram of a first-order linear active disturbance rejection control system according to an embodiment of the present disclosure.

FIG. 4 is a closed-loop response diagram of a first-order linear ADRC system under different parameters according to an embodiment of the present disclosure.

FIG. 5 is a simplified diagram of a feedforward-type first-order ADRC control system according to an embodiment of the present disclosure.

FIG. 6 is a response diagram at position r of a first-order linear ADRC system when different feedforward links G_{F} are selected, according to an embodiment of the present disclosure.

FIG. 7 is a closed-loop response diagram of a first-order linear ADRC system when different feedforward links G_{F} are selected, according to an embodiment of the present disclosure.

FIG. 8 is a comparison diagram of feedforward-type first-order ADRC, first-order linear ADRC, and a PI controller according to an embodiment of the present disclosure.

FIG. 9 is a comparison diagram of anti-disturbance effects between feedforward-type first-order ADRC and a PI controller, according to an embodiment of the present disclosure.

FIG. 10 is a comparison diagram of control effects between ADRC and feedforward-type first-order ADRC in a main steam temperature system according to an embodiment of the present disclosure.

FIG. 11 is a schematic structural diagram of an optimization device for a feedforward-type first-order ADRC controller according to an embodiment of the present disclosure.

FIG. 12 is a schematic structural diagram of an electronic device according to an embodiment of the present disclosure.

### DETAILED DESCRIPTION

Technical solutions according to embodiments of the present disclosure will be described clearly below in combination with accompanying drawings of the embodiments of the present disclosure. Obviously, the embodiments described below are a part of the embodiments of the present disclosure, rather than all embodiments of the present disclosure. On a basis of the embodiments of the present disclosure, all other embodiments obtained by those skilled in the art shall fall within the scope of the present disclosure.

Terms such as “first” and “second” in the description and claims of the present disclosure are used only to distinguish between similar objects, rather than to describe a particular order or sequence. It should be understood that the data as used can be interchanged where appropriate, to enable the embodiments of the present disclosure described herein to be implemented in an order other than that illustrated or described herein. Also, the objects distinguished by the terms such as “first” and “second” are usually objects of the same type. The quantity of objects is not limited. For example, a first object may be one first object or a plurality of first objects. In addition, “and/or” throughout the description and claims indicates at least one of the objects associated with “and/or”. The character “/” generally indicates that the associated objects before and after the character are in an “or” relationship.

An optimization method for a feedforward-type first-order ADRC controller, an optimization device for the feedforward-type first-order ADRC controller, an electronic device, and a readable storage medium according to the embodiments of the present disclosure will be described below in detail with reference to specific embodiments and application scenarios thereof in combination with the accompanying drawings.

The optimization method for the feedforward-type first-order ADRC controller may be applied in a terminal and may be specifically executed by hardware or software in the terminal.

The terminal includes, but is not limited to, a portable communication device such as a mobile phone or a tablet computer. It should also be understood that in some embodiments, the terminal may not be a portable communication device, but a desktop computer.

In each of the following embodiments, a terminal including a display and a touch-sensitive surface is described. However, it should be understood that the terminal may include one or more other physical user interface devices, such as a physical keyboard, a mouse, and a joystick.

In the optimization method for the feedforward-type first-order ADRC controller according to the embodiments of the present disclosure, an execution subject of the optimization method for the feedforward-type first-order ADRC controller may be an electronic device or a functional module or a functional entity in the electronic device capable of implementing the optimization method for the feedforward-type first-order ADRC controller. The electronic device mentioned in the embodiments of the present disclosure includes, but is not limited to, a mobile phone, a tablet computer, a computer, a camera, and a wearable device. The optimization method for the feedforward-type first-order ADRC controller according to the embodiments of the present disclosure will be described below by taking the electronic device serving as the execution subject as an example.

The inventor found that an adjustment time period of a system when a value of λ is 0.1 is significantly longer than an adjustment time period of the system when the value of λ is 10, it indicates that dynamic performance of the system is relatively slow under the value of λ being 0.1.

Based on an analysis of this phenomenon, the present disclosure proposes an optimization method for a feedforward-type first-order ADRC controller. This method adds a feedforward transfer function after values are set to serve as a transition link of the controller.

A series of comparative experiments were conducted in the present disclosure. Their results show that the adjustment time period of the system using the optimization method for the feedforward-type first-order ADRC controller is significantly shortened, and the dynamic performance is significantly improved. Beneficial effects are specifically reflected in two aspects. In a first aspect, a response speed of the system is greatly improved, enabling the system to respond more quickly to an input signal and adjust output in a timely manner, which satisfies requirements of application scenarios such as real-time control and rapid adjustment. In a second aspect, stability of the system is significantly enhanced, and performance fluctuations caused by value changes are reduced, ensuring that the system may operate stably and reliably under different operating conditions, and laying a solid foundation for wide application of this technology in complex and changeable actual engineering environments.

The optimization method for the feedforward-type first-order ADRC controller adds a feedforward link G_{F} to a classical linear active disturbance rejection control system. The method includes operations at steps S1, S2, S3, and S4.

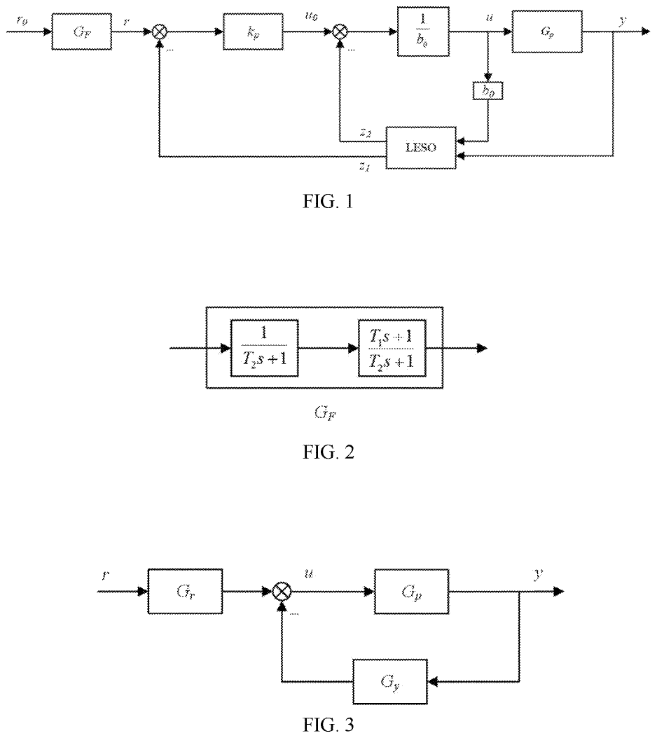

At step S1, parameters of a transfer function Gₚ of a first-order inertial time-delay system, such as a controlled object shown in FIG. 1, are identified by using a step response curve method or a method for simplifying the transfer function. The parameters of the transfer function of the controlled object include a steady-state gain, an inertial time constant, and a delay time.

In other embodiments, the parameters of the transfer function Gₚ of the first-order inertial time-delay system being the controlled object shown in FIG. 1 are identified by using an open-loop step response curve method. The involved parameters include a steady-state gain K, an inertial time constant T, and a delay time τ.

At step S2, subsequent to completing identification of the parameters of the transfer function Gₚ of the controlled object, a linear extended state observer is expressed as:

$$\{ \begin{matrix}{\dot{z}}_{1} ( t ) = {z}_{2} ( t ) + {b}_{0} u ( t ) - {β}_{1} ( {z}_{1} ( t ) - y ( t ) ) \\ {\dot{z}}_{2} ( t ) = {β}_{2} ( {z}_{1} ( t ) - y ( t ) )\end{matrix} ,$$

in which: t represents a time, r(t), u(t), and y(t) respectively represent a system reference value, an input value, and an output value, and z₁(t) and z₂(t) represent state variable estimated values; a feedback law is u₀(t)=kₚ(r(t)−z₁(t)); and a compensation law is

$$u ( t ) = \frac{{u}_{0} ( t ) - {z}_{2} ( t )}{{b}_{0}} ;$$

An extended state observer bandwidth ωₒ and a linear error feedback law bandwidth ω_{c} are defined by using a bandwidth parameterization method, and linear extended state observer parameters β₁ and β₂ and a linear error feedback control law parameter kₚ are calculated, where

$${β}_{1} = 2 {ω}_{o} , {β}_{2} = {ω}_{o}^{2} , and {k}_{p} = {ω}_{c} ,$$

in which to-be-tuned parameters for first-order linear active disturbance rejection control include ω₀, ω_{c}, and a control quantity gain b₀ of the extended state observer, to simplify parameter tuning.

In some embodiments, in S2, for the controlled object being the first-order inertial time-delay system, the transfer function is determined based on the following formula:

$${G}_{p} ( s ) = \frac{y ( s )}{u ( s )} = \frac{K}{Ts + 1} {e}^{- τ S} ,$$

where: Gₚ(S) is the transfer function; u(s) and y(S) are Laplace transforms of system input u(t) and system output y(t), respectively; K is the steady-state gain, and T is the inertial time constant; and T is the delay time.

At step S3, a bandwidth of a first-order active disturbance rejection controller is defined as

$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} ,$$

so that ω_{c}=(1+λ)ω_{A} and

$${ω}_{o} = \frac{1 + 2 λ}{λ} {ω}_{A} ,$$

### and in S2,

$${β}_{1} = \frac{2 ( 1 + 2 λ )}{λ} {ω}_{A} , {β}_{2} = \frac{{( 1 + 2 λ )}^{2}}{{λ}^{2}} {ω}_{A}^{2} ,$$

and kₚ=(1+2λ)ω_{A}, and the to-be-tuned parameters include ω_{A}, λ and b₀.

In some embodiments, in S3, λ is in a range of 0<λ≤1.

In other embodiments, λ may be 0.1.

In some embodiments, in S3, the controller is designed according to a pole-zero cancellation principle, and

$${ω}_{A} = \frac{{ω}_{o}^{2} {ω}_{c}}{2 {ω}_{o} {ω}_{c} + {ω}_{o}^{2}} = \frac{1}{T} ,$$

where: ω_{A} is the bandwidth of the first-order active disturbance rejection controller; ω_{O} is the extended state observer bandwidth; ω_{c} is the linear error feedback law bandwidth; and T is the inertial time constant.

At step S4, a feedforward link is added to the first-order linear ADRC, that is, adding a feedforward transfer function

$${G}_{F} ( S ) = \frac{{T}_{1} s + 1}{{( {T}_{2} s + 1 )}^{2}}$$

subsequent to setting values. T₁ and T₂, are parameters of the feedforward link. The feedforward link serves as a transition link of the first-order ADRC, then system input is r=r₀G_{F}.

In some embodiments, in S4, when the controller is implemented in DCS or PLC configuration, there is no feedforward transfer function

$$\frac{{T}_{1} s + 1}{{( {T}_{2} s + 1 )}^{2}} ;$$

and two lead-lag links are used for configuration. A numerator time constant of the first lead-lag link is 0, and denominator time constants of the two lead-lag links are the same, that is,

$${G}_{F} ( s ) = \frac{1}{{T}_{2} + 1} \times \frac{{T}_{1} s + 1}{{T}_{2} s + 1} .$$

A configuration diagram of the feedforward link G_{F} is shown in FIG. 2.

In some embodiments, T₂>0; and T₁ is greater than T₂.

In other embodiments, T₁ and T₂ may be determined based on the following formulas, respectively:

$${T}_{1} = \frac{1}{{ω}_{c}} ,$$

where ω_{c} is the linear error feedback law bandwidth; and

$${T}_{2} = \frac{1}{{ω}_{o}} ,$$

where ωₒ is the extended state observer bandwidth.

In some embodiments, in a case that

$${ω}_{A} = \frac{1}{T} ,$$

an initial value of the control quantity gain b₀ of the extended state observer is determined based on the following formula:

$${b}_{0} = max \{ 2 \frac{K}{T} \frac{τ}{T} \frac{{( 1 + 2 λ )}^{2}}{λ ( 2 + λ )} , \frac{K}{T} \} .$$

In some embodiments, starting from the initial value of the control quantity gain b₀ of the extended state observer, the control quantity gain b₀ of the extended state observer may gradually reduce, to make overshoot of closed-loop control be smaller than or equal to 5%.

In other embodiments, starting from the initial value of the control quantity gain b₀ of the extended state observer, the control quantity gain b₀ of the extended state observer may gradually increase, to make no overshoot occur during the closed-loop control.

With the optimization method for the feedforward-type first-order ADRC controller according to the embodiments of the present disclosure, a feedforward link is added after values are set, and is used as a transition link of the system. A series of simulation experiments have been conducted to verify effectiveness of the method of the present disclosure. Results of the simulation experiments show that the method proposed in the present disclosure can significantly improve dynamic response performance of the system.

Specific embodiments of an optimization method for a feedforward-type first-order ADRC controller are described in detail below.
(1) In a case that a controlled object is a first-order inertial time-delay system, a transfer function of the controlled object is

$${G}_{p} ( s ) = \frac{y ( s )}{u ( s )} = \frac{K}{T s + 1} {e}^{- τ s} ,$$

a differential equation of the transfer function may be written as \dot{y}(t)=b₀u(t)+f(t)

$$f ( t ) = - {b}_{0} u ( t ) - \frac{1}{T} y ( t ) + \frac{K}{T} u ( t - τ )$$

represents total system disturbance, b₀ represents an input gain, u(t) represents system input, and y(t) represents system output.

Then, the differential equation is converted into a state-space equation as follows:

$$\{ \begin{matrix}{\dot{x}}_{1} ( t ) = {x}_{2} ( t ) + {b}_{0} u ( t ) \\ {\dot{x}}_{2} ( t ) = \dot{f} ( t )\end{matrix} ,$$

in which:
x₁(t)=y(t), and x₂(t)=f(t).

A corresponding extended state observer may be expressed as:

$$\{ \begin{matrix}{\dot{z}}_{1} ( t ) = {z}_{2} ( t ) + {b}_{0} u ( t ) - {β}_{2} ( {z}_{1} ( t ) - y ( t ) ) \\ {\dot{z}}_{2} ( t ) = - {β}_{2} ( {z}_{1} ( t \} - y ( t ) )\end{matrix} ,$$

in which:
z₁(t)→y(t) and z₂(t)→f(t) represent state variable estimated values, β₁ and β₂ represent observer gains.

A feedback law in FIG. 1 is u₀(t)=kₚ(r(t)−z₁(t)). A compensation law is

$$u ( t ) = \frac{{u}_{0} ( t ) - {z}_{2} ( t )}{{b}_{0}} .$$

An extended state observer bandwidth ωₒ and a linear error feedback law bandwidth ω_{c} are defined by using a bandwidth parameterization method. Then, linear extended state observer parameters β₁ and β₂ and a linear error feedback control law parameter kₚ are calculated, where

$${β}_{1} = 2 {ω}_{o} , {β}_{2} = {ω}_{o}^{2} , and {k}_{p} = {ω}_{c} .$$

First-order linear ADRC may be simplified as follows:

$$u ( s ) = {G}_{r} ( s ) r ( s ) - {G}_{y} ( s ) y ( s ) = \frac{{ω}_{c}}{{b}_{0}} \frac{{( s + {ω}_{0} )}^{2}}{s ( s + 2 {ω}_{0} + {ω}_{c} )} r ( s ) - \frac{2 {ω}_{0} {ω}_{c} + {ω}_{0}^{2}}{{b}_{0}} \frac{s + \frac{{ω}_{0}^{2} {ω}_{c}}{2 {ω}_{0} {ω}_{c} + {ω}_{0}^{2}}}{s ( s + 2 {ω}_{0} + {ω}_{c} )} y ( s ) ,$$

$$in which :$$

$$\{ \begin{matrix}{G}_{r} ( s ) = \frac{{ω}_{c}}{{b}_{0}} \frac{{( s + {ω}_{0} )}^{2}}{s ( s + 2 {ω}_{0} + {ω}_{c} )} \\ {G}_{y} ( s ) = \frac{2 {ω}_{o} {ω}_{c} + {ω}_{0}^{2}}{{b}_{0}} \frac{s + \frac{{ω}_{0}^{2} {ω}_{c}}{2 {ω}_{0} {ω}_{c} + {ω}_{0}^{2}}}{s ( s + 2 {ω}_{0} + {ω}_{c} )}\end{matrix}$$

A simplified diagram of the system is shown in FIG. 3.
(2) Next, a bandwidth of a first-order active disturbance rejection controller is defined as

$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} , so that {ω}_{c} = ( 1 + 2 λ ) {ω}_{A} and$$

$${ω}_{o} = \frac{1 + 2 λ}{λ} {ω}_{A} .$$

Accordingly,

$${β}_{1} = \frac{2 ( 1 + 2 λ )}{λ} {ω}_{A} , {β}_{2} = \frac{{( 1 + 2 λ )}^{2}}{{λ}^{2}} {ω}_{A}^{2} ,$$

and kₚ=(1+2λ)ω_{A}. In this case, to-be-tuned parameters include ω_{A}, λ and b₀.

Then, Gᵣ(s) and G_{y}(s) may be re-expressed as:

$$\{ \begin{matrix}{G}_{r} ( s ) = \frac{( 1 + 2 λ ) {ω}_{A}}{{b}_{0}} \frac{{( s + ( 1 + 2 λ ) / {λω}_{A} )}^{2}}{s ( s + ( 1 + 2 λ ) ( 1 + 2 / λ ) {ω}_{A} )} \\ {G}_{y} ( s ) = \frac{{( 1 + 2 λ )}^{3} / {λ}^{2} {ω}_{A}^{2}}{{b}_{0}} \frac{s + {ω}_{A}}{s ( s + ( 1 + 2 λ ) ( 1 + 2 / λ ) {ω}_{A} )}\end{matrix} .$$

As shown in FIG. 3, a closed-loop transfer function of the system is:

$$G ( s ) = \frac{{G}_{r} ( s ) {G}_{p} ( s )}{1 + {G}_{y} ( s ) {G}_{p} ( s )} .$$

A closed-loop characteristic equation of the system may be written as:

$$1 + {G}_{y} ( s ) {G}_{p} ( s ) = 1 + \frac{1}{{b}_{0}} \frac{{( 1 + 2 λ )}^{3}}{{λ}^{2}} \frac{K}{T} \frac{1}{Ts ( Ts + ( 1 + 2 λ ) ( 1 + 2 / λ ) )} {e}^{- τ s} = 0.$$

(3) By observing

$${G}_{y} ( s ) = \frac{{( 1 + 2 λ )}^{3} / {λ}^{2} {ω}_{A}^{2}}{{b}_{0}} \frac{s + {ω}_{A}}{s ( s + ( 1 + 2 λ ) ( 1 + 2 / λ ) {ω}_{A} )} ,$$

it is found that

$$\frac{s + {ω}_{A}}{s ( s + ( 1 + 2 λ ) ( 1 + 2 / λ ) {ω}_{A} )}$$

is symmetric with respect to the reciprocal of λ. In response to selecting a value of λ₁ and λ₂=1/λ₁, both λ₁ and λ₂ have the same zeros and poles.

Meanwhile, when preceding coefficients are also set to be the same, i.e.,

$$\frac{{( 1 + 2 {λ}_{1} )}^{3} / {λ}_{1}^{2}}{{b}_{01}} = \frac{{( 1 + 2 λ )}^{3} / {λ}_{2}^{2}}{{b}_{02}} ,$$

G_{y}(s) is completely the same, and thus closed-loop poles are the same as inferred from the characteristic equation.

Parameters in the transfer function of the controlled object are set as follows. A steady-state gain is K=1, an inertial time constant is T=1, and a delay time is τ=1.

When λ=0.1

$${G}_{y} ( s ) = \frac{2}{{b}_{01} s} \frac{172. 8 {ω}_{A}^{2} ( s + {ω}_{A} )}{s + 25.2 {ω}_{A}} , {G}_{r} ( S ) = \frac{1}{{b}_{01} s} \frac{1.2 {{ω}_{A} ( s + 12 {ω}_{A} )}^{2}}{s + 25.2 {ω}_{A}} .$$

$$When$$

$$λ = 10 ,$$

$${G}_{y} ( s ) = \frac{1}{{b}_{02} s} \frac{92.61 {ω}_{A}^{2} ( s + {ω}_{A} )}{s + 25.2 {ω}_{A}} , {G}_{r} ( s ) = \frac{1}{{b}_{02} s} \frac{21 {{ω}_{A} ( s + 2.1 {ω}_{A} )}^{2}}{s + 25.2 {ω}_{A}} .$$

In response to b₀₁/b₀₂=172.8/92−61=640/343, G_{y}(s) is completely the same, and Gᵣ(s) differs.

An initial value of b₀ is set as

$${b}_{0} = max \{ 2 \frac{K}{T} \frac{τ}{T} \frac{{( 1 + 2 λ )}^{2}}{λ ( 2 + λ )} , \frac{K}{T} \} .$$

When λ=0.1, b₀₁=13.7. When λ=10, b₀₂=7.35.

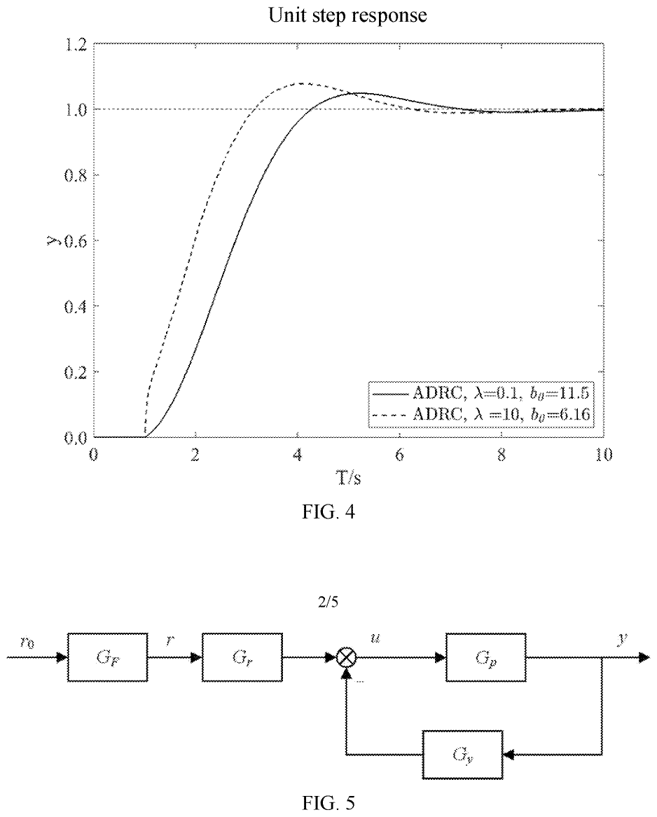

Starting from the initial value, b₀ is gradually reduced until overshoot of the closed-loop control reaches 5%, with b₀₁/b₀₂=640/343. Simulation experiments are conducted with λ=01, b₀₁=11.5 and λ=10, b₀₂=0.16, and experiment results are shown in FIG. 4. Through comparison of impacts of different values of the parameter λ on an adjustment characteristic of the system, it is found that, compared with a case when λ=0.1, in a case when λ is 10, the system may complete the adjustment process and reach a steady state faster than.

It is found that through analysis, poles of Gᵣ(s) are the same in this case, but zeros of Gᵣ(s) differ. When λ=0.1, the zero of Gᵣ(s) is −12ω_{A}. When λ=10, the zero of Gᵣ(s) is −2.1ω_{A}. An absolute value of the zero when λ=0.1 is greater than an absolute value of the zero when λ=10.

In summary, the reason why the system with λ=10 has a shorter adjustment time period than a system with λ=0.1 is a difference in the zeros of Gᵣ(s).
(5) A value of λ is usually in a range of 0<λ≤1. To make a case with λ=0.1 achieve the same effect as a case with λ=10, a feedforward function is added to change the zero of Gᵣ(s). By setting

$${G}_{F} = \frac{{( s + {ω}_{c} )}^{2}}{{( s + {ω}_{o} )}^{2}}$$

(since 0<λ≤1, ωₒ≥ω_{c}), when it is considered that G_{F} is a lead transfer function, it is necessary to reduce the order of the numerator. Meanwhile, to ensure the steady-state gain to be 1, G_{F} is modified to

$${G}_{F} = \frac{1 / {ω}_{c} s + 1}{{( 1 / {ω}_{o} s + 1 )}^{2}} .$$

For more generalization, G_{F} is further expressed as

$${G}_{F} = \frac{{T}_{1} s + 1}{{( {T}_{2} s + 1 )}^{2}} .$$

Typically, T₂=1/ωₒ, while T₁ is selectable, and T₁>T₂, and T₁ is preferably 1/ω_{c}. T₁ may also take other values not equal to 1/ω_{c}.

FIG. 5 is a simplified diagram of a feedforward-type first-order ADRC control system. When λ=0.1, and a feedforward transfer function

$${G}_{F} = \frac{{T}_{1} s + 1}{{( {T}_{2} s + 1 )}^{2}} = \frac{1 / {ω}_{c} s + 1}{{( 1 / {ω}_{o} s + 1 )}^{2}}$$

is added after the value is set,

$${G}_{y} ( S ) = \frac{1}{{b}_{01} s} \frac{172. 8 {ω}_{A}^{2} ( s + {ω}_{A} )}{s + 25.2 {ω}_{A}} ,$$

$$and$$

$${G}_{r}^{*} ( s ) = {G}_{F} ( s ) \times {G}_{r} ( s ) = \frac{1}{{b}_{01} s} \frac{144 {ω}_{A}^{2} ( s + 1.2 {ω}_{A} )}{s + 25.2 {ω}_{A}} .$$

A zero of Gᵣ*(s) is −1.2ω_{A}. The zero of Gᵣ(S) before the feedforward link is added is −12ω_{A}. The zero −1.2ω_{A} is closer to an imaginary axis than the zero −12ω_{A}, thus resulting in a shorter adjustment time period and a faster system response speed.
(6) Comparative experiments are conducted on different types of feedforward links, based on which a feedforward link suitable for this system is selected.

Parameter settings include λ=0.1 and b₀=13.1. Four different types of G_{F} are selected and are

$${G}_{F 1} = \frac{{( {T}_{1} s + 1 )}^{2}}{{( {T}_{2} s + 1 )}^{2}} , {G}_{F 2} = \frac{{T}_{1} s + 1}{{( {T}_{2} s + 1 )}^{2}} ,$$

$${G}_{F 3} = \frac{{T}_{1} s + 1}{{T}_{2} s + 1} , and {G}_{F 4} = \frac{1}{{T}_{2} s + 1} ,$$

respectively.

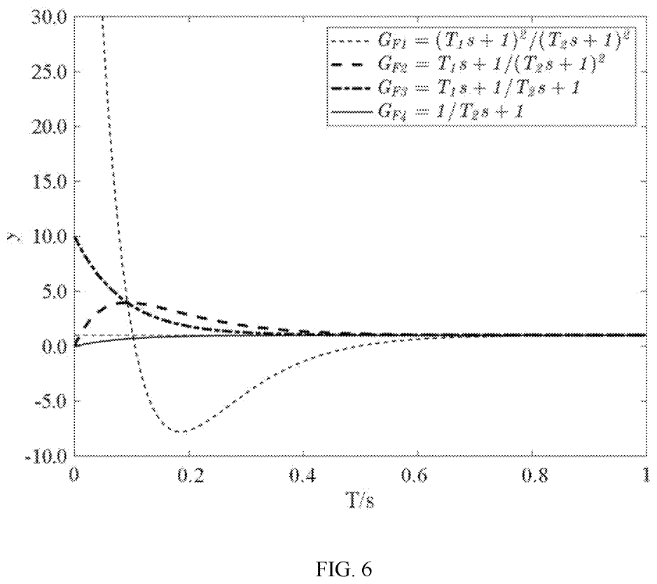

FIG. 6 is a response diagram at position r of a first-order linear ADRC system when different feedforward links G_{F} are selected. It can be seen from FIG. 6 that when G_{F1} is selected, there is a jump at 0s, with a maximum amplitude reaching 30. When G_{F2} is selected, an overshoot phenomenon occurs, and an overshoot magnitude may be adjusted by changing the value of λ. When G_{F3} is selected, there is also a jump at 0s, with a maximum amplitude of 10. When G_{F4} is selected, there is no overshoot phenomenon, but a dynamic response speed is relatively slow.

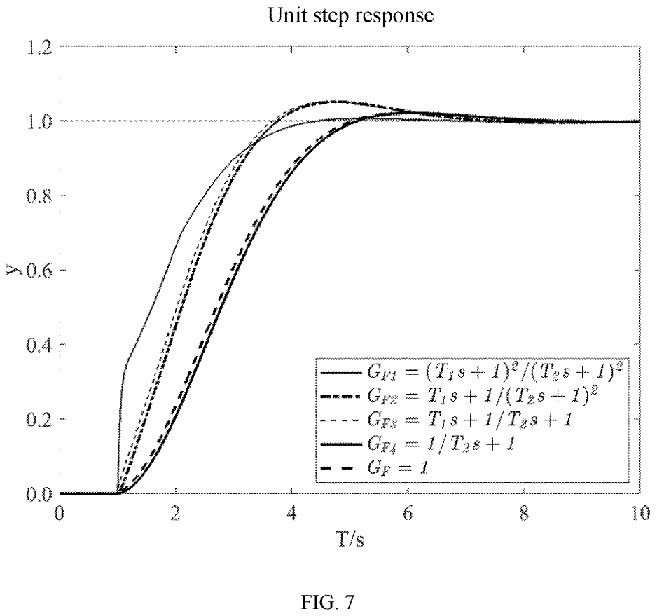

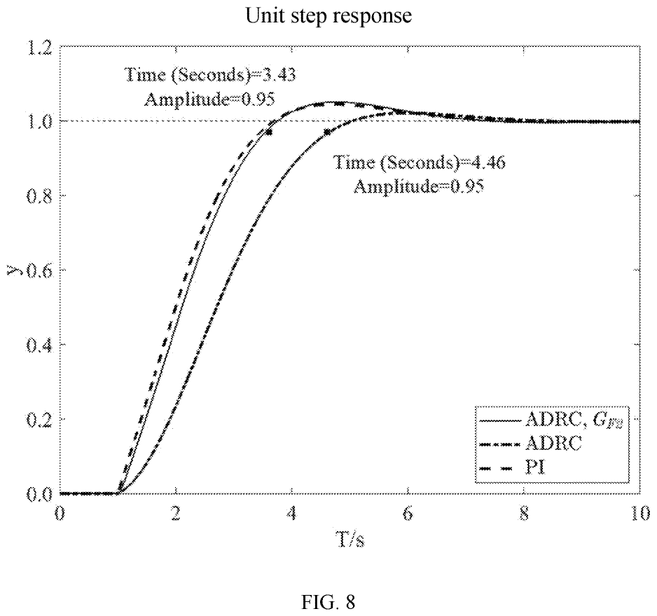

FIG. 7 is a closed-loop response diagram of a first-order linear ADRC system when different feedforward links G_{F} are selected. It can be seen from FIG. 7 that when G_{F1} is selected, the system response speed is the fastest, but an amplitude jump occurs at an initial stage of the response. When G_{F2} and G_{F3} are selected, the response speed is significantly faster under a case where the system overshoot does not exceed 5%. When G_{F4} is selected, the system response speed is slightly slower.

In summary, the effect is the best when

$${G}_{F 2} = \frac{{T}_{1} s + 1}{{( {T}_{2} s + 1 )}^{2}}$$

is selected.

### First Embodiment

As shown in FIG. 8, the present disclosure compares closed-loop response curves of feedforward-type first-order ADRC, first-order linear ADRC, and a PI system.

The feedforward-type first-order ADRC adopts G_{F2} with parameters of λ=0.1 and b₀=13.1. The first-order linear ADRC has parameters of λ=0.1 and b₀=13.1. The PI controller is

$${G}_{pi} = {k}_{pi} ( 1 + \frac{1}{{T}_{pi} s} ) ,$$

where kₚᵢ=0.5 and Tₚᵢ=1. It can be seen from FIG. 8 that the first-order linear ADRC takes 4.46 s to reach an amplitude of 0.95, while the feedforward-type first-order ADRC takes 3.43 s to reach an amplitude of 0.95. The feedforward-type first-order ADRC improves the response speed by 23.1% compared with the first-order linear ADRC, demonstrating better dynamic response performance. However, the feedforward-type first-order ADRC lags slightly behind the PI controller in terms of response speed.

### Second Embodiment

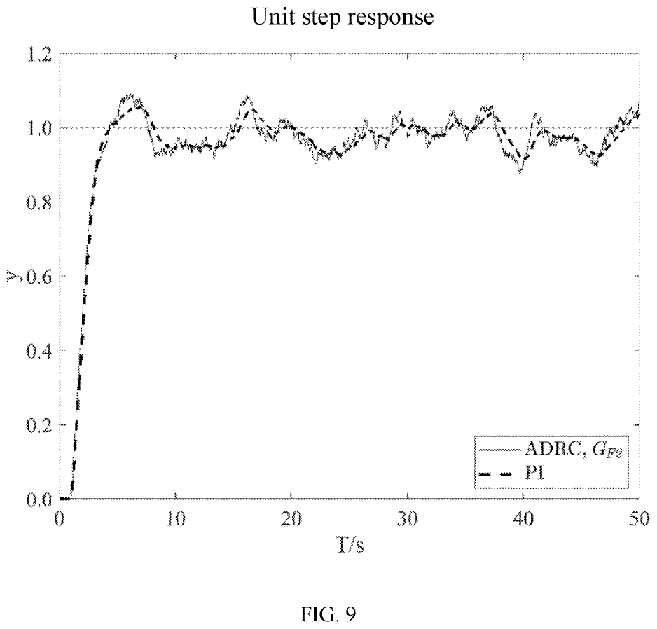

As shown in FIG. 9, a comparison diagram of anti-disturbance effects of feedforward-type first-order ADRC and a PI controller is given. The feedforward-type first-order ADRC adopts G_{F2} with parameters of λ=0.1 and b₀=13.1. The PI controller has kₚᵢ=0.5 and Tₚᵢ=1.

The same white noise is added to the two controllers. Through simulation calculations, it can be seen that the feedforward-type first-order ADRC takes 3.63 s for its closed-loop response amplitude to reach 0.95, while the PI controller takes 3.98 s for its closed-loop response amplitude to reach 0.95. A maximum amplitude of the feedforward-type first-order ADRC is 1.054, while a maximum amplitude of the PI controller is 1.087.

In summary, under a case of inputting the same white noise, the comparison shows that compared with the PI controller, the improved ADRC exhibits better performance in terms of response speed, system stability, and reliability.

### Third Embodiment

In a main steam temperature system of a 330MW circulating fluidized bed unit, a leading zone model and an inert zone model are important components.

$${P}_{1} ( s ) = \frac{- 1.6165}{{( 19.363 s + 1 )}^{2}}$$

represents the leading zone model, which is located in a front segment of a superheater in the main steam temperature control system and is capable of reflecting a steam temperature change trend at an early stage.

$${P}_{2} ( S ) = \frac{1.5528}{{( 28.234 s + 1 )}^{4}}$$

represents the inert zone model, which is a part after the leading zone in the superheater and describes a steam temperature change characteristic of this zone. The main steam temperature system may be simplified as

$$P ( s ) = \frac{- 2.51}{{( 80 s + 1 )}^{2}} {e}^{- 84.2 s} .$$

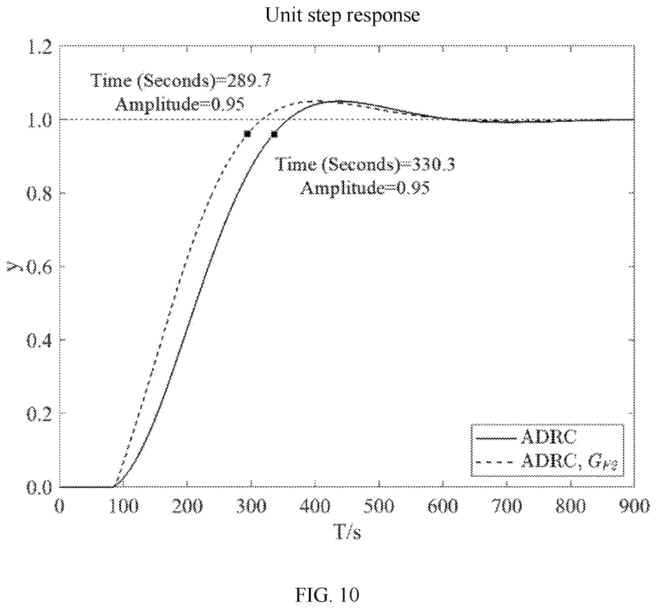

As shown in FIG. 10, the present disclosure compares control effects of the ADRC and improved ADRC in the main steam temperature system. Overshoot of each of the ADRC system and the improved ADRC system is 5%. The ADRC system has parameters of λ==0.1 and b₀=−0.385, while the improved ADRC system has parameters of λ=0.1 and b₀=−0.435. It can be seen from FIG. 10 that under a case where the system overshoot is 5%, the ADRC takes 330.3 s for its closed-loop response amplitude to reach 0.95, while the improved ADRC takes 289.7 s for its closed-loop response amplitude to reach 0.95. The improved ADRC reduces the adjustment time period by 12.3% compared with the first-order linear ADRC, showing a significantly faster response speed.

An execution subject of the optimization method for the feedforward-type first-order ADRC controller according to the embodiments of the present disclosure may be an optimization device for a feedforward-type first-order ADRC controller. In the embodiments of the present disclosure, the optimization device for the feedforward-type first-order ADRC controller executing the optimization method for the feedforward-type first-order ADRC controller is taken as an example to illustrate the optimization device for the feedforward-type first-order ADRC controller according to the embodiments of the present disclosure.

The embodiments of the present disclosure further provide an optimization device for a feedforward-type first-order ADRC controller.

The optimization device for the feedforward-type first-order ADRC controller adds a feedforward link G_{F} to a classical linear active disturbance rejection control system.

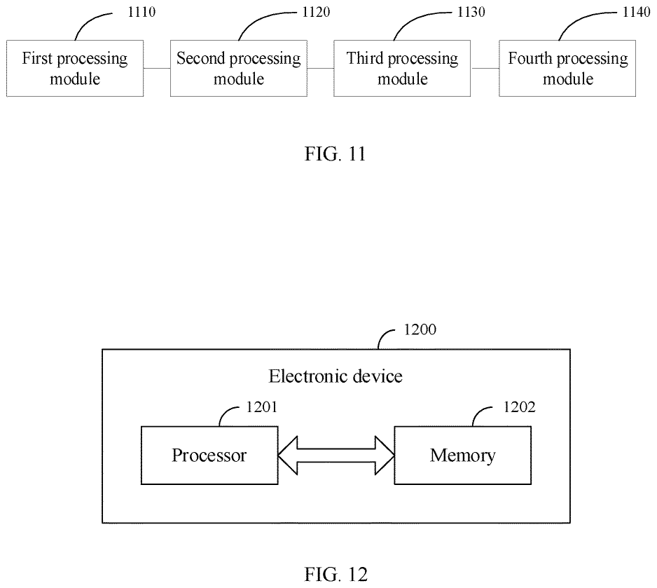

As shown in FIG. 11, the optimization device for the feedforward-type first-order ADRC controller includes a first processing module 1110, a second processing module 1120, a third processing module 1130, and a fourth processing module 1140.

The first processing module 1110 is configured to identify parameters of a transfer function Gₚ of a first-order inertial time-delay system being a controlled object by using a step response curve method or a method for simplifying the transfer function. The parameters of the transfer function of the controlled object include a steady-state gain, an inertial time constant, and a delay time.

The second processing module 1120 is configured to: express, subsequent to completing identification of the parameters of the transfer function Gₚ of the controlled object, a linear extended state observer as:

$$\{ \begin{matrix}{\dot{z}}_{1} ( t ) = {z}_{2} ( t ) + {b}_{0} u ( t ) - {β}_{1} ( {z}_{1} ( t ) - y ( t ) ) \\ {\dot{z}}_{2} ( t ) = - {β}_{2} ( {z}_{1} ( t ) - y ( t ) )\end{matrix} ,$$

in which: t represents a time, r(t), (t), and y(t) respectively represent a system reference value, an input value, and an output value, and z₁(t) and z₂(t) represent state variable estimated values; a feedback law is u₀(t)=kₚ(r(t)−z₁(t)); and a compensation law is

$$u ( t ) = \frac{{u}_{0} ( t ) - {z}_{2} ( t )}{{b}_{0}} ;$$

and define an extended state observer bandwidth ω₀ and a linear error feedback law bandwidth ω_{c} by using a bandwidth parameterization method, and calculate linear extended state observer parameters β₁ and β₂ and a linear error feedback control law parameter kₚ, where

$${β}_{1} = 2 {ω}_{o} , {β}_{2} = {ω}_{o}^{2} ,$$

and kₚ=ω_{c}, in which to-be-tuned parameters for first-order linear active disturbance rejection control include ω₀, ω_{c}, and a control quantity gain b₀ of the extended state observer, to simplify parameter tuning;
The third processing module 1130 is configured to define a bandwidth of a first-order active disturbance rejection controller as

$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} , so that$$

$${ω}_{c} = ( 1 + 2 λ ) {ω}_{A} and {ω}_{o} = \frac{1 + 2 λ}{λ} {ω}_{A} ,$$

and in the second processing module,

$${β}_{1} = \frac{2 ( 1 + 2 λ )}{λ} {ω}_{A} , {β}_{2} = \frac{{( 1 + 2 λ )}^{2}}{{λ}^{2}} {ω}_{A}^{2} , and {k}_{p} = ( 1 + 2 λ ) {ω}_{A} ,$$

and the to-be-tuned parameters include ω_{A}, λ and b₀.

The fourth processing module 1140 is configured to add a feedforward link to first-order linear ADRC, that is, add a feedforward transfer function

$${G}_{F} ( s ) = \frac{{T}_{1} s + 1}{{( {T}_{2} s + 1 )}^{2}}$$

subsequent to setting values. T₁ and T₂. are parameters of the feedforward link. The feedforward link serves as a transition link of the first-order ADRC, then system input is r=rdG_{F}.

With the optimization device for the feedforward-type first-order ADRC controller according to the embodiments of the present disclosure, a feedforward link is added after values are set, and is used as a transition link of the system. A series of simulation experiments have been conducted to verify effectiveness of the method of the present disclosure. Results of the simulation experiments show that the method proposed in the present disclosure can significantly improve dynamic response performance of the system.

The optimization device for the feedforward-type first-order ADRC controller in the embodiments of the present disclosure may be an electronic device or a component in the electronic device, such as an integrated circuit or a chip. The electronic device may be a terminal or a device other than the terminal. Exemplarily, the electronic device may be a mobile phone, a tablet computer, a laptop computer, a handheld computer, an in-vehicle electronic device, a mobile internet device (MID), an augmented reality (AR)/virtual reality (VR) device, a robot, a wearable device, an ultra-mobile personal computer (UMPC), a netbook or a personal digital assistant (PDA), or the like. The electronic device may also be a server, a network attached storage (NAS), a personal computer (PC), a television (TV), a teller machine, a self-service machine, or the like, which is not limited in the embodiments of the present disclosure.

The optimization device for the feedforward-type first-order ADRC controller in the embodiments of the present disclosure may be an apparatus having an operation system. The operation system may be an Android operation system, an IOS operation system, or other possible operation systems, which is not limited in the embodiments of the present disclosure.

The optimization device for the feedforward-type first-order ADRC controller according to the embodiments of the present disclosure may realize various processes implemented by method embodiments of FIG. 1 to FIG. 10, and details are omitted herein for the avoidance of repetition.

In some embodiments, as shown in FIG. 12, the embodiments of the present disclosure further provide an electronic device 1200. The electronic device 1200 includes a processor 1201, a memory 1202, and a computer program stored in the memory 1202 and executable on the processor 1201. The computer program, when executed by the processor 1201, implements various processes of the embodiments of the optimization method for the feedforward-type first-order ADRC controller as described above and may achieve the same technical effect. For the avoidance of repetition, details are omitted herein.

It should be noted that the electronic device in the embodiments of the present disclosure includes a mobile electronic device and a non-mobile electronic device as described above.

The embodiments of the present disclosure further provide a non-transitory computer-readable storage medium, having a computer program stored thereon. The computer program, when executed by the processor, implements various processes of the embodiments of the optimization method for the feedforward-type first-order ADRC controller as described above and may achieve the same technical effect. For the avoidance of repetition, details are omitted herein.

The processor is a processor in the electronic device as described in the above embodiments. The readable storage medium includes a computer-readable storage medium, such as a computer read-only memory ROM, a random access memory RAM, and a magnetic disk or an optical disk.

The embodiments of the present disclosure further provide a computer program product, including a computer program. The computer program, when executed by the processor, implements the optimization method for the feedforward-type first-order ADRC controller as described above.

The processor is the processor in the electronic device as described in the above embodiments. The readable storage medium includes a computer-readable storage medium, such as a computer read-only memory ROM, a random access memory RAM, and a magnetic disk or an optical disk.

The embodiments of the present disclosure further provide a chip. The chip includes a processor and a communication interface. The communication interface is coupled to the processor. The processor is used for running a program or an instruction. In this way, various processes of the embodiments of the optimization method for the feedforward-type first-order ADRC controller as described above are realized, and the same technical effect can be achieved. For the avoidance of repetition, details are omitted herein.

It should be understood that the chip mentioned in the embodiments of the present disclosure may also be referred to as a system-level chip, a system chip, a chip system or a system-on-chip, or the like.

It should be noted that, terms herein “comprise”, “include” or any other variations thereof are meant to cover non-exclusive including, such that the process, method, article or device including a series of elements do not only include those elements, but also include other elements that are not explicitly listed, or also include inherent elements of the process, method, article or device. In a case that there are no more restrictions, an element qualified by the statement “comprises a . . . ” does not exclude the presence of additional identical elements in the process, method, article or device that includes the said element. In addition, it should be noted that the scope of the methods and devices in the implementations of the present disclosure are not limited to performing the functions in the order shown or discussed, and may also include performing the functions in a substantially simultaneous manner or in a reverse order according to the involved functions. For example, the described methods may be performed in an order different from the described order, and various steps may be added, omitted, or combined. In addition, features described with reference to some examples may be combined in other examples.

From the above description of the implementations, those skilled in the art may clearly understand that the methods of the above embodiments can be implemented by software and a necessary general hardware platform. Of course, the method can also be implemented by hardware, but the former is a preferred implementation in many cases. Based on such understanding, the technical solutions of the present disclosure essentially, or the part contributing to the related art may be embodied in a form of a computer software product. The computer software product is stored in a storage medium (such as ROM/RAM, a magnetic disk, and an optical disc), and includes several instructions for allowing a terminal (which may be a mobile phone, a computer, a server, or a network device) to execute methods described in the embodiments of the present disclosure.

The embodiments of the present disclosure have been described above with reference to the accompanying drawings, but the present disclosure is not limited to the above-described specific implementations, which are merely schematic and not restrictive, and those skilled in the art can make many forms under the inspiration of the present disclosure without departing from the purpose of the present disclosure and the scope of the claims, all of which fall within the protection of the present disclosure.

In the description of this specification, descriptions with reference to the terms “an embodiment”, “some embodiments”, “schematic embodiments”, “examples”, “specific examples”, or “some examples”, etc. mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although the embodiments of the present disclosure have been shown and described above, it can be understood by those skilled in the art that various changes, modifications, replacements, and variations can be made to these embodiments without departing from the principles and ideas of the present disclosure. The scope of the present disclosure is defined by the claims as attached and their equivalents.

What is claimed is:

1. An optimization method for a feedforward-type first-order Active Disturbance Rejection Control (ADRC) controller, wherein a feedforward link G_{F} is added to a classical linear active disturbance rejection control system, the method comprising:
S1: identifying parameters of a transfer function Gₚ of a first-order inertial time-delay system being a controlled object by using a step response curve method or a method for simplifying the transfer function, wherein the parameters of the transfer function of the controlled object comprise a steady-state gain, an inertial time constant, and a delay time;
S2: subsequent to completing identification of the parameters of the transfer function Gₚ of the controlled object, expressing a linear extended state observer as:
$$\{ \begin{matrix}{\dot{z}}_{1} ( t ) = {z}_{2} ( t ) + {b}_{0} u ( t ) - {β}_{1} ( {z}_{1} ( t ) - y ( t ) ) \\ {\dot{z}}_{2} ( t ) = - {β}_{2} ( {z}_{1} ( t ) - y ( t ) )\end{matrix} ,$$
wherein:
t represents a time, r(t), u(t), and y(t) respectively represent a system reference value, an input value, and an output value, and z₁(t) and z₂(t) represent state variable estimated values;
a feedback law is u₀(t)=kₚ(r(t)−z₁(t)); and
a compensation law is
$$u ( t ) = \frac{{u}_{0} ( t ) - {z}_{2} ( t )}{{b}_{0}} ;$$
and
defining an extended state observer bandwidth ωₒ and a linear error feedback law bandwidth ω_{c} by using a bandwidth parameterization method, and calculating linear extended state observer parameters β₁ and β₂ and a linear error feedback control law parameter kₚ, where
$${β}_{1} = 2 {ω}_{o} , {β}_{2} = {ω}_{o}^{2} ,$$
and kₚ=ω_{c}, wherein to-be-tuned parameters for first-order linear active disturbance rejection control comprise ωₒ, ω_{c}, and a control quantity gain b₀ of the extended state observer, to simplify parameter tuning;
S3: defining a bandwidth of a first-order active disturbance rejection controller as
$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} ,$$
so that ω_{c}=(1+2λ)ω_{A} and
$${ω}_{o} = \frac{1 + 2 λ}{λ} {ω}_{A} ,$$
and in S2,
$${β}_{1} = \frac{2 ( 1 + 2 λ )}{λ} {ω}_{A} , {β}_{2} = \frac{{( 1 + 2 λ )}^{2}}{{λ}^{2}} {ω}_{A}^{2} ,$$
and kₚ=(1+2λ)ω_{A}, and the to-be-tuned parameters comprise ω_{A}, λ and b₀; and
S4: adding a feedforward link to first-order linear ADRC, that is, adding a feedforward transfer function
$${G}_{F} ( s ) = \frac{{T}_{1} s + 1}{{( {T}_{2} s + 1 )}^{2}}$$
subsequent to setting values, wherein T₁ and T₂ are parameters of the feedforward link, the feedforward link serves as a transition link of the first-order ADRC, system input is r=r₀G_{F}.

2. The optimization method for the feedforward-type first-order ADRC controller according to claim 1, wherein in S2, for the controlled object being the first-order inertial time-delay system, the transfer function is determined based on the following formula:
$${G}_{p} ( s ) = \frac{y ( s )}{u ( s )} = \frac{K}{Ts + 1} {e}^{- τ s} ,$$
where:
Gₚ(s) is the transfer function;
u(S) and y(s) are Laplace transforms of system input u(t) and system output y(t), respectively;
K is the steady-state gain, and T is the inertial time constant; and
τ is the delay time.

3. The optimization method for the feedforward-type first-order ADRC controller according to claim 1, wherein in S3, λ is in a range of 0<λ≤1.

4. The optimization method for the feedforward-type first-order ADRC controller according to claim 1, wherein in S3, the controller is designed according to a pole-zero cancellation principle, and
$${ω}_{A} = \frac{{ω}_{o}^{2} {ω}_{c}}{2 {ω}_{o} {ω}_{c} + {ω}_{o}^{2}} = \frac{1}{T} ,$$
where:
ω_{A} is the bandwidth of the first-order active disturbance rejection controller;
ωₒ is the extended state observer bandwidth;
ω_{c} is the linear error feedback law bandwidth; and
T is the inertial time constant.

5. The optimization method for the feedforward-type first-order ADRC controller according to claim 1, wherein:
in S4, when the controller is implemented in DCS or PLC configuration, there is no feedforward transfer function
$$\frac{{T}_{1} s + 1}{{( {T}_{2} s + 1 )}^{2}} ;$$
and
two lead-lag links are used for configuration, wherein a numerator time constant of the first lead-lag link is 0, and denominator time constants of the two lead-lag links are the same, that is,
$${G}_{F} = \frac{1}{{T}_{2} s + 1} \times \frac{{T}_{1} s + 1}{{T}_{2} s + 1} .$$

6. The optimization method for the feedforward-type first-order ADRC controller according to claim 1, wherein:
T₂>0; and
T₁ is greater than T₂.

7. The optimization method for the feedforward-type first-order ADRC controller according to claim 1, wherein:
$${T}_{1} = \frac{1}{{ω}_{c}} ,$$
where ω_{c} is the linear error feedback law bandwidth; and
$${T}_{2} = \frac{1}{{ω}_{o}} ,$$
where ωₒ is the extended state observer bandwidth.

8. The optimization method for the feedforward-type first-order ADRC controller according to claim 1, wherein in a case that
$${ω}_{A} = \frac{1}{T} ,$$
an initial value of the control quantity gain b₀ of the extended state observer is determined based on the following formula:
$${b}_{0} = max \{ 2 \frac{K}{T} \frac{τ}{T} \frac{{( 1 + 2 λ )}^{2}}{λ ( 2 + λ )} , \frac{K}{T} \} .$$

9. The optimization method for the feedforward-type first-order ADRC controller according to claim 8, further comprising:
starting from the initial value of the control quantity gain b₀ of the extended state observer, gradually reducing the control quantity gain b₀ of the extended state observer, to make overshoot of closed-loop control be smaller than or equal to 5%; or
starting from the initial value of the control quantity gain b₀ of the extended state observer, gradually increasing the control quantity gain b₀ of the extended state observer, to make no overshoot occur during the closed-loop control.

10. An electronic device comprising a memory, a processor, and a computer program stored in the memory and executable on the processor, wherein the processor, when executing the computer program, implements an optimization method for a feedforward-type first-order Active Disturbance Rejection Control (ADRC) controller, wherein a feedforward link G_{F} is added to a classical linear active disturbance rejection control system, the method comprising:
S1: identifying parameters of a transfer function Gₚ of a first-order inertial time-delay system being a controlled object by using a step response curve method or a method for simplifying the transfer function, wherein the parameters of the transfer function of the controlled object comprise a steady-state gain, an inertial time constant, and a delay time;
S2: subsequent to completing identification of the parameters of the transfer function Gₚ of the controlled object, expressing a linear extended state observer as:
$$\{ \begin{matrix}{\dot{z}}_{1} ( t ) = {z}_{2} ( t ) + {b}_{0} u ( t ) - {β}_{1} ( {z}_{1} t ) - y ( t ) ) \\ {\dot{z}}_{2} ( t ) = - {β}_{2} ( {z}_{1} ( t ) - y ( t ) )\end{matrix} ,$$
wherein:
t represents a time, r(t), u(t), and y(t) respectively represent a system reference value, an input value, and an output value, and z₁(t) and z₂(t) represent state variable estimated values;
a feedback law is u₀(t)=kₚ(r(t)−z₁(t)); and
a compensation law is
$$u ( t ) = \frac{{u}_{0} ( t ) - {z}_{2} ( t )}{{b}_{0}} ;$$
and
defining an extended state observer bandwidth ωₒ and a linear error feedback law bandwidth ω_{c} by using a bandwidth parameterization method, and calculating linear extended state observer parameters β₁ and β₂ and a linear error feedback control law parameter kₚ, where
$${β}_{1} = 2 {ω}_{o} , {β}_{2} = {ω}_{o}^{2} ,$$
and kₚ=ω_{c}, wherein to-be-tuned parameters for first-order linear active disturbance rejection control comprise ωₒ, ω_{c}, and a control quantity gain b₀ of the extended state observer, to simplify parameter tuning;
S3: defining a bandwidth of a first-order active disturbance rejection controller as
$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} ,$$
so that ω_{c}=(1+2λ)ω_{A} and
$${ω}_{o} = \frac{1 + 2 λ}{λ} {ω}_{A} ,$$
and in S2,
$${β}_{1} = \frac{2 ( 1 + 2 λ )}{λ} {ω}_{A} , {β}_{2} = \frac{{( 1 + 2 λ )}^{2}}{{λ}^{2}} {ω}_{A}^{2} ,$$
and kₚ=(1+2λ)ω_{A}, and the to-be-tuned parameters comprise ω_{A}, λ and b₀; and
S4: adding a feedforward link to first-order linear ADRC, that is, adding a feedforward transfer function
$${G}_{F} ( s ) = \frac{{T}_{1} s + 1}{{( {T}_{2} s + 1 )}^{2}}$$
subsequent to setting values, wherein T₁ and T₂ are parameters of the feedforward link, the feedforward link serves as a transition link of the first-order ADRC, system input is r=r₀G_{F}.

11. The electronic device according to claim 10, wherein in S2, for the controlled object being the first-order inertial time-delay system, the transfer function is determined based on the following formula:
$${G}_{p} ( s ) = \frac{y ( s )}{u ( s )} = \frac{K}{Ts + 1} {e}^{- τ s} ,$$
where:
Gₚ(s) is the transfer function;
u(s) and y(s) are Laplace transforms of system input u(t) and system output y(t), respectively;
K is the steady-state gain, and T is the inertial time constant; and
τ is the delay time.

12. The electronic device according to claim 10, wherein in S3, λ is in a range of 0<λ≤1.

13. The electronic device according to claim 10, wherein in S3, the controller is designed according to a pole-zero cancellation principle, and
$${ω}_{A} = \frac{{ω}_{o}^{2} {ω}_{c}}{2 {ω}_{o} {ω}_{c} + {ω}_{o}^{2}} = \frac{1}{T} ,$$
where:
ω_{A} is the bandwidth of the first-order active disturbance rejection controller;
ωₒ is the extended state observer bandwidth;
ω_{c} is the linear error feedback law bandwidth; and
T is the inertial time constant.

14. The electronic device according to claim 10, wherein:
in S4, when the controller is implemented in DCS or PLC configuration, there is no feedforward transfer function
$$\frac{{T}_{1} s + 1}{{( {T}_{2} s + 1 )}^{2}} ;$$
and
two lead-lag links are used for configuration, wherein a numerator time constant of the first lead-lag link is 0, and denominator time constants of the two lead-lag links are the same, that is,
$${G}_{F} ( s ) = \frac{1}{{T}_{2} s + 1} \times \frac{{T}_{1} s + 1}{{T}_{2} s + 1} .$$

15. The electronic device according to claim 10, wherein:
T₂>0; and
T₁ is greater than T₂.

16. The electronic device according to claim 10, wherein:
$${T}_{1} = \frac{1}{{ω}_{c}} ,$$
where ω_{c} is the linear error feedback law bandwidth; and
$${T}_{2} = \frac{1}{{ω}_{o}} ,$$
where ωₒ is the extended state observer bandwidth.

17. The electronic device according to claim 10, wherein in a case that
$${ω}_{A} = \frac{1}{T} ,$$
an initial value of the control quantity gain b₀ of the extended state observer is determined based on the following formula:
$${b}_{0} = max \{ 2 \frac{K}{T} \frac{τ}{T} \frac{{( 1 + 2 λ )}^{2}}{λ ( 2 + λ )} , \frac{K}{T} \} .$$

18. The electronic device according to claim 17, wherein the method further comprises:
starting from the initial value of the control quantity gain b₀ of the extended state observer, gradually reducing the control quantity gain b₀ of the extended state observer, to make overshoot of closed-loop control be smaller than or equal to 5%; or
starting from the initial value of the control quantity gain b₀ of the extended state observer, gradually increasing the control quantity gain b₀ of the extended state observer, to make no overshoot occur during the closed-loop control.

19. A non-transitory computer-readable storage medium, having a computer program stored thereon, wherein the computer program, when executed by a processor, implements an optimization method for a feedforward-type first-order Active Disturbance Rejection Control (ADRC) controller, wherein a feedforward link G_{F} is added to a classical linear active disturbance rejection control system, the method comprising:
S1: identifying parameters of a transfer function Gₚ of a first-order inertial time-delay system being a controlled object by using a step response curve method or a method for simplifying the transfer function, wherein the parameters of the transfer function of the controlled object comprise a steady-state gain, an inertial time constant, and a delay time;
S2: subsequent to completing identification of the parameters of the transfer function Gₚ of the controlled object, expressing a linear extended state observer as:
$$\{ \begin{matrix}{\dot{z}}_{1} ( t ) = {z}_{2} ( t ) + {b}_{0} u ( t ) - {β}_{1} ( {z}_{1} ( t ) - y ( t ) ) \\ {\dot{z}}_{2} ( t ) = - {β}_{2} ( {z}_{1} ( t ) - y ( t ) )\end{matrix} ,$$
wherein:
t represents a time, r(t), u(t), and y(t) respectively represent a system reference value, an input value, and an output value, and z₁(t) and z₂(t) represent state variable estimated values;
a feedback law is u₀(t)=kₚ(r(t)−z₁(t)); and
a compensation law is
$$u ( t ) = \frac{{u}_{0} ( t ) - {z}_{2} ( t )}{{b}_{0}} ;$$
and
defining an extended state observer bandwidth ωₒ and a linear error feedback law bandwidth ω_{c} by using a bandwidth parameterization method, and calculating linear extended state observer parameters β₁ and β₂ and a linear error feedback control law parameter kₚ, where
$${β}_{1} = 2 {ω}_{o} , {β}_{2} = {ω}_{o}^{2} ,$$
and kₚ=ω_{c}, wherein to-be-tuned parameters for first-order linear active disturbance rejection control comprise ωₒ, ω_{c}, and a control quantity gain b₀ of the extended state observer, to simplify parameter tuning;
S3: defining a bandwidth of a first-order active disturbance rejection controller as
$${ω}_{A} = \frac{{ω}_{o}^{2} {ω}_{c}}{2 {ω}_{o} {ω}_{c} + {ω}_{o}^{2}} and λ = \frac{{ω}_{c}}{{ω}_{o}} ,$$
so that ω_{c}=1+2λ)ω_{A} and
$${ω}_{o} = \frac{1 + 2 λ}{λ} {ω}_{A} ,$$
and in S2,
$${β}_{1} = \frac{2 ( 1 + 2 λ )}{λ} {ω}_{A} , {β}_{2} = \frac{{( 1 + 2 λ )}^{2}}{{λ}^{2}} {ω}_{A}^{2} ,$$
and kₚ=(1+2λ)ω_{A}, and the to-be-tuned parameters comprise ω_{A}, λ and b₀; and
S4: adding a feedforward link to first-order linear ADRC, that is, adding a feedforward transfer function
$${G}_{F} ( s ) = \frac{{T}_{1} s + 1}{{( {T}_{2} s + 1 )}^{2}}$$
subsequent to setting values, wherein T₁ and T₂ are parameters of the feedforward link, the feedforward link serves as a transition link of the first-order ADRC, system input is r=r₀G_{F}.

20. The non-transitory computer-readable storage medium according to claim 19, wherein in S2, for the controlled object being the first-order inertial time-delay system, the transfer function is determined based on the following formula:
$${G}_{p} ( s ) = \frac{y ( s )}{u ( s )} = \frac{K}{Ts + 1} {e}^{- τ s} ,$$
where:
Gₚ(s) is the transfer function;
u(s) and y(s) are Laplace transforms of system input u(t) and system output y(t), respectively;
K is the steady-state gain, and T is the inertial time constant; and
τ is the delay time.
